(19) United States
(12) Patent Application Publication
(10) Pub. No.: US 2006/0225585 A1
(43) Pub. Date: Oct. 12, 2006

(54) Sheet feeding mechanism capable of adjusting sheet feeding force

(75) Inventor: Devon Shyu, Hsinchu (TW)

Correspondence Address: CHARLES E. BAXLEY, ESQ., 90 JOHN STREET, THIRD FLOOR, NEW YORK, NY, 10038, US

(73) Assignee: Avision Inc.

(21) Appl. No.: 11/399,824

(22) Filed: Apr. 7, 2006

(30) Foreign Application Priority Data
Apr. 11, 2005 (TW) 094111346

(51) Int. Cl. B44B 5/00

(52) U.S. Cl. 101/3.1

(57) ABSTRACT

A sheet feeding mechanism includes an auto document feeder roller (ADF roller), a pad, an elastic element and an adjusting device. The pad is pressed against the ADF roller by the elastic force of the elastic element. The adjusting device is used to adjust the deformation of the elastic element for adjusting the elastic force of the elastic element, and the friction between the pad and the ADF roller is changed. Before the document feeding process, the user can adjust the adjusting device to provide an applicable friction force. Herewith plural sheets can be fed one by one.

### BACKGROUND OF THE INVENTION

1. Field of the Invention

The present invention relates to a document feeding mechanism, particularly for the application of feeding a plurality of paper sheets one by one from a paper feed end of the automatic document feeder (ADF) and into an image input or output equipment by the ADF. The image input or output equipment includes a scanner, printer, imaging machine, and multi-function printer.

2. Prior Art

To improve convenience in use, the image input or output equipment can be equipped with an automatic document feeder. The automatic document feeder is used to feed a plurality of paper sheets from a paper cartridge one by one into a feeding path of the image input or output equipment for scanning or copying or printing.

The paper feeder end of the automatic document feeder is equipped with a feeder mechanism. The feeder mechanism is capable of feeding and separating paper sheets one by one from the paper cartridge to the paper feeder path.

As shown in FIG. 1, a conventional feeder mechanism 10 includes an automatic document feeder roller (ADF roller) 12, a pad 14, and an elastic element 16. The ADF roller 12 and the pad 14 are opposite each other and in contact. One end of the elastic element 16 is fixed, while the other end of the elastic element 16 is connected with the pad 14. The deformation of elastic element 16 provides adequate elastic force to the pad 14; thereby the appropriate friction is maintained at the position where the pad 14 is in contact with the ADF roller 12.

Since the document feeder mechanism 10 provide fixed friction force, when the thickness or the weight of paper to be fed is not fit in with the paper separating friction of the document feeder mechanism 10, then miss feeding or multiple feeding will occur.

In other words, automatic sheet separating efficiency can be assured if the automatic sheet separating mechanism is capable of providing proper friction to suit the thickness or weight of the paper sheets to be fed.

### SUMMARY OF THE INVENTION

The objective of this invention is to provide a sheet separating mechanism with adjustable sheet separating force, to solve the problem of discrepancy between the friction of the sheet separating mechanism and the thickness or weight of the paper to be fed, thereby the automatic document feeding mechanism can achieve more accurate sheet separating efficiency.

Another objective of the present invention is to provide a document feeding mechanism with adjustable sheet separating force, thereby to achieve more accurate sheet separating efficiency, so that the user can reduce the time wasted in troubleshooting in case of miss feeding or multiple feeding during operation of the image input equipment or image output equipment.

To achieve the objectives and performance disclosed herein, the document feeding mechanism includes an auto document feeder (ADF) roller, a pad in close contact with the auto document feeding roller, and an elastic element exert a force to the pad, so that the pad contact with the ADF roller. Further an adjusting device connected with the elastic element for the purpose of adjusting the force of the elastic element on the pad, thereby the friction force between the pad and the ADF roller can be adjusted properly to enable accurate feeding of paper sheets of a different thickness or weight one by one in a smooth process.

### BRIEF DESCRIPTION OF THE DRAWINGS

FIG. 1 is a schematic view of a prior art of document feeder.

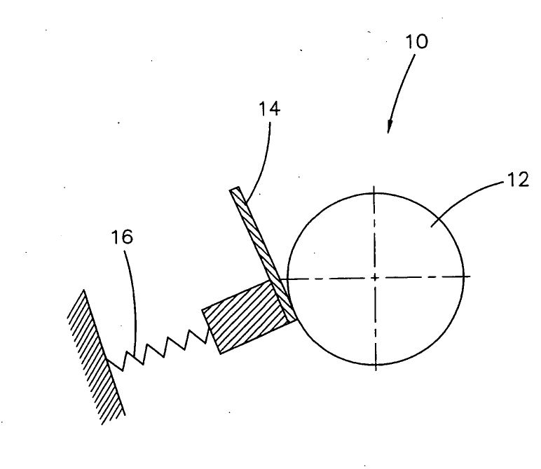

FIG. 2 is an exterior view of a first embodiment of the present invention.

FIG. 3 is a schematic view of the first embodiment of the present invention.

FIG. 4 is schematic view of the first embodiment of the present invention in use.

FIG. 5 is an exterior view of a second embodiment of the present invention.

FIG. 6 is a schematic view of a third embodiment of the present invention.

FIG. 7 is a schematic view of the third embodiment of the present invention in use.

### DETAILED DESCRIPTION OF THE PREFERRED EMBODIMENT

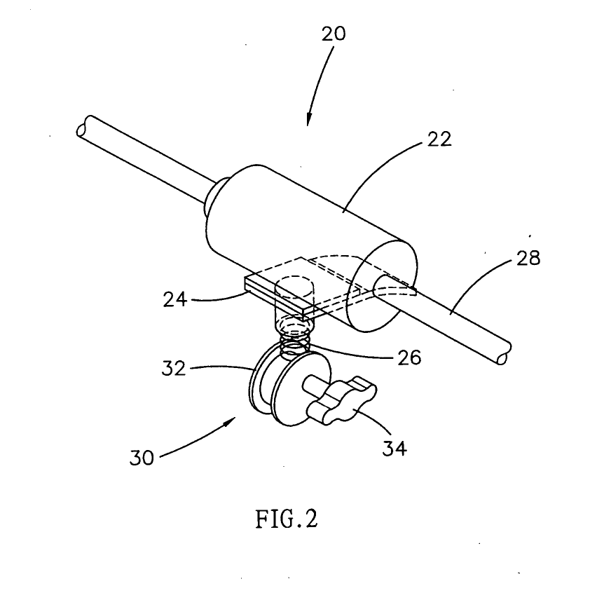

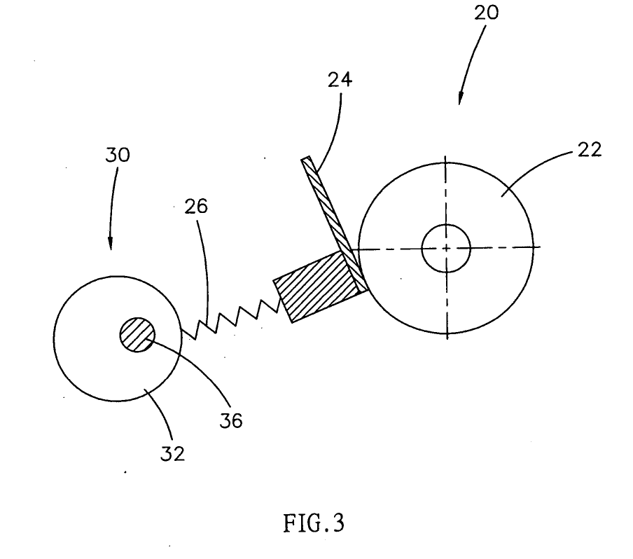

Please refer to FIGS. 2 and 3 showing a sheet feeding mechanism 20 installed at the feeder end of an automatic document feeding device, comprising an auto document feeder roller (ADF roller) 22, a pad 24, a elastic element 26 and an adjusting device 30.

The ADF roller 22 is combined with a turning shaft 28. The turning shaft 28 is driven and turned by a driving device (not shown in diagram), thereby simultaneously driving and turning the ADF roller 22.

The pad 24 is installed at one side of the ADF roller 22, forming an included angle with the ADF roller 22. Partial surface of the pad 24 is in contact with the outside surface of the ADF roller 22.

The elastic element 26 is installed at the bottom side of the pad 24. One end of the elastic element 26 is in connection with the bottom side of the pad 24, while the other end of the elastic element 26 is installed at the adjusting device 30.

The adjusting device 30 includes an adjusting unit 32 and a driving unit 34. The adjusting unit 32 is connected with one end of the elastic element 26. The driving unit 34 is connected with the adjusting unit 32. The driving unit 34 is used to drive the adjusting unit 32 to produce relative motion with the elastic element 26. Importantly, relative movement of the adjusting unit 32 and the elastic element 26 can achieve the change of deformation of the elastic element 26.

For example, the elastic element 26 is a spring, the adjusting unit 32 is a cam, and the driving unit 34 is a turning knob, wherein one end of the spring rests on the periphery of the cam.

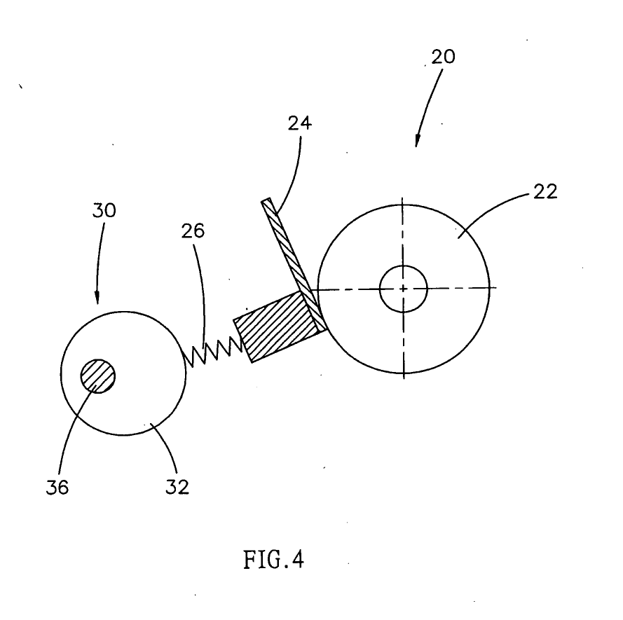

When the user turns the driving unit 34 shown in FIG. 2, also referring to FIGS. 3 and 4, the periphery of the adjusting unit 32 and the elastic element 26 produce relative movement. Since the adjusting unit 32 is a cam, turning the adjusting unit 32 can to changes the distance between the end of the elastic element 26 and a fixing shaft 36 of the adjusting unit 32, thereby changing the extent of deformation of the elastic element 26.

As far as the spring is concerned, the elasticity is in proportion to the deformation of the spring. When the deformation of the elastic element 26 increases, the force applied by the elastic element 26 on the pad 24 also increases. When the normal force between the pad 24 and the ADF roller 22 increases, the friction between the pad 24 and the ADF roller 22 increases accordingly. For paper having larger thickness or more weight, more friction will be more suitable for separating the paper sheets, enabling better efficiency in separating the paper sheets one by one. Conversely, adjusting of the adjusting device 30 to decrease the friction between the pad 24 and the ADF roller 22 will enable better efficiency for separating the paper sheets smaller thickness or lower weight.

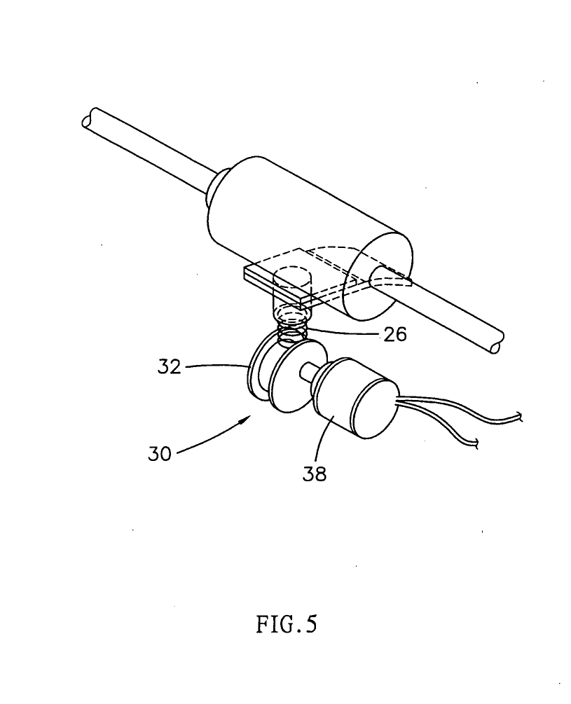

Referring to FIG. 5 showing an adjusting device 30 composed of an adjusting unit 32 and a driving unit 38, wherein the adjusting unit 32 is equivalent to the structure described above. The driving unit 38 is an electric motor, such as a stepping motor or a servomotor.

Before the paper is fed, at least one outside switch or software program can be used to control the driving unit 38, thereby producing relative movement of the adjusting unit 32 and the elastic element 26, and achieving the purpose of changing the elasticity of the elastic element 26.

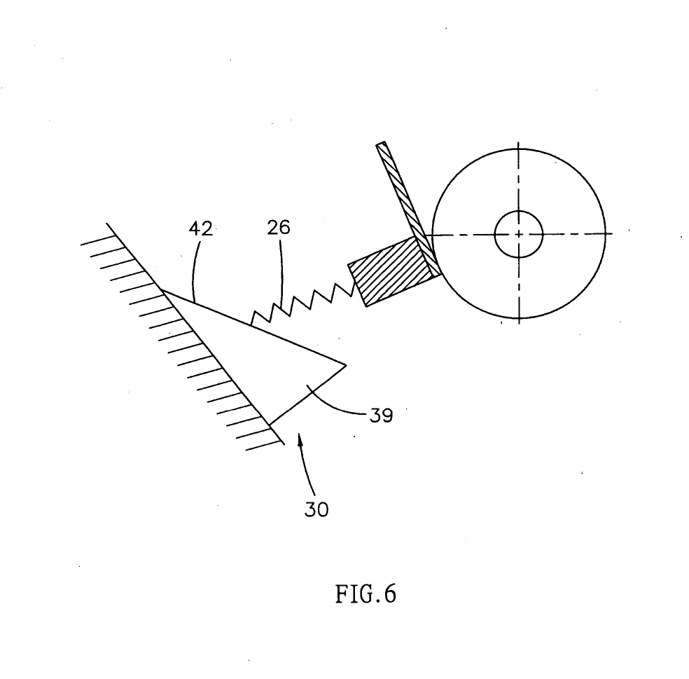

Please refer to FIG. 6 showing an adjusting unit 39 of an adjusting device 30 as a movable block, one side of the block being an inclined part 42, the inclined part 42 being in touch with one end of the elastic element 26. As in the aforementioned embodiment, the adjusting unit 39 can be manually or electrically operated to produce relative movement to the elastic element 26.

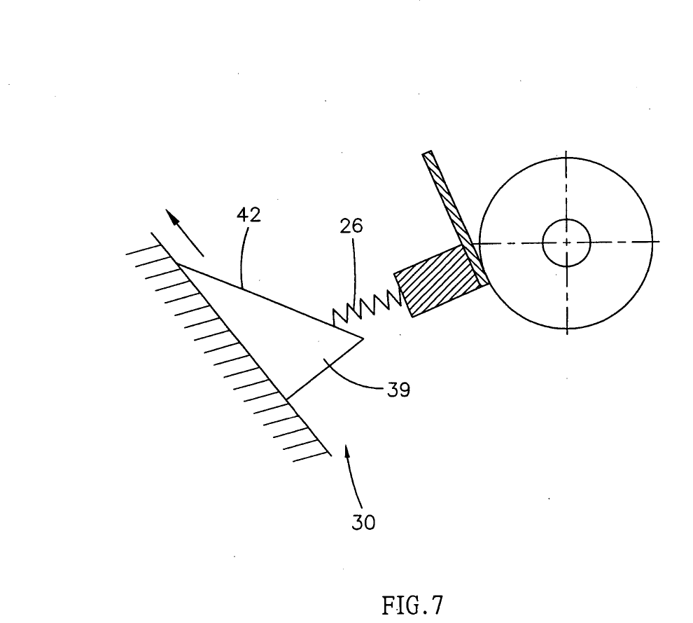

Please refer to FIG. 7. When the adjusting unit 39 is moving, one end of the elastic element 26 changes the contact position with the inclined part 42, thereby reaching the purpose of changing the elasticity of the elastic element 26.

The technical approach and anticipated objectives disclosed in the present invention can be concluded as follows:

1. The technical approach of the present invention is designed to change the elasticity of the elastic element 26, thereby changing the friction between the pad 24 and the ADF roller 22, so that the paper sheets having various thickness can be separated adequately with appropriate friction and fed into the automatic feeding device by the automatic sheet feeding mechanism.

2. The changing of the elasticity of the elastic element 26 is achieved by a set of adjusting device 30. The adjusting device 30 provides an adjusting unit 32 or 39. The adjusting unit 32 or 39 is capable of producing relative movement of the elastic element 26, changing the deformation of the elastic element 26, thereby reaching the purpose of adjusting the elasticity of the elastic element 26.

3. Using the design of the present invention, the appropriate feeding friction force can be adjusted during the automatic feeding process, to enhance the accuracy of the automatic feeding process, thereby reducing the time wasted in troubleshooting in incorrect or multiple feeding.

Although this invention has been disclosed and illustrated with reference to particular embodiments, the principles involved are susceptible for use in numerous other embodiments that will be apparent to persons skilled in the art. This invention is, there, to be limited only as indicated by the scope of the appended claim.

What is claimed is:

1. A sheet feeding mechanism with adjustable sheet separating force, for application to automatic paper feeding devices in image input and output equipment, comprising:
an automatic document feeder roller mounted at a feeding end of the automatic paper feeding device;
a pad mounted on the feeding end, one side of said pad being opposite said automatic document feeder roller;
an elastic element mounted at another side of said pad which serving to push said pad to the automatic document feeder roller;
an adjusting device having an adjusting unit, the adjusting unit connect with one end of the elastic element, and the adjusting unit being capable of producing relative movement to the elastic element, thereby adjusting the force applied by the elastic element pushing on the pad.

2. The sheet feeding mechanism with adjustable sheet separating force of claim 1, wherein the adjusting unit of said adjusting device is a cam, a periphery of the cam being in connection with one end of said elastic element.

3. The sheet feeding mechanism with adjustable sheet separating force of claim 1, wherein the adjusting unit of said adjusting device is a movable block, the block having an incline part, and the incline part being in connection with one end of said elastic element.

4. The sheet feeding mechanism with adjustable sheet separating force of claim 1, wherein said adjusting device has a driving unit connected with the adjusting unit.

5. The sheet feeding mechanism with adjustable sheet separating force of claim 4, wherein, the driving unit is a knob.

6. The sheet feeding mechanism with adjustable sheet separating force of claim 4, wherein the driving unit is an electric motor.

7. The sheet feeding mechanism with adjustable sheet separating force of claim 1, wherein the elastic element is a spring.
